(19) United States
(12) Patent Application Publication
(10) Pub. No.: US 2015/0246345 A1
(43) Pub. Date: Sep. 3, 2015

(54) SCR CATALYSTS HAVING IMPROVED LOW TEMPERATURE PERFORMANCE, AND METHODS OF MAKING AND USING THE SAME

(71) Applicant: JOHNSON MATTHEY PUBLIC LIMITED COMPANY, LONDON (GB)

(72) Inventors: Jillian Elaine COLLIER, Reading (GB); Desiree DURAN-MARTIN, Reading (GB); Raj Rao RAJARAM, Berkshire (GB)

(21) Appl. No.: 14/633,658

(22) Filed: Feb. 27, 2015

Related U.S. Application Data
(60) Provisional application No. 61/946,075, filed on Feb. 28, 2014.

(51) Int. Cl. B01J 29/072; C01B 39/44; B01J 29/76; C01B 39/02; B01J 29/85; B01J 29/68

(52) U.S. Cl. CPC B01J 29/072; B01J 29/85; B01J 29/68; B01J 29/7615; C01B 39/02; C01B 39/44; B01J 2229/186

(57) ABSTRACT

SCR-active molecular sieve based-catalysts are produced by combining a molecular sieve with at least one ionic iron species and at least one organic compound to form a mixture, then calcining the mixture to remove the at least one organic compound. This process improves the dispersion of the iron within the molecular sieve compared to an iron-containing molecular sieve that is not treated with an organic compound. Iron-containing ferrierite zeolites exhibit a selective catalytic reduction of nitrogen oxides with NH₃ or urea of greater than 25% conversion at 300° C. in exhaust gases prior to ageing or exposure to steam. Iron-containing beta zeolites exhibit a selective catalytic reduction of nitrogen oxides with NH₃ or urea of: (a) greater than 40% conversion at 300° C. and (b) greater than 80% conversion at 400° C., in exhaust gases after ageing for 20 hours at 700° C. in the presence of 10% H₂O.

### BACKGROUND OF THE INVENTION

1. Field of the Invention

The invention relates generally to molecular sieve based-catalysts used in selectively converting nitrogen oxides (NOₓ) present in a gas stream to nitrogen using a nitrogenous reductant such as ammonia (NH₃) or urea (CO(NH₂)₂) and in particular it relates to Fe-containing catalysts which are particularly active at relatively low temperatures in relation to conventional Fe zeolite catalysts. The molecular sieve in these catalysts is preferably a zeolite or a silicoaluminophosphate (SAPO).

2. Description of Related Art

Selective catalytic reduction (SCR) systems utilize NH₃ as a reductant to reduce NOₓ to elemental nitrogen. A principal application of SCR technology is in the treatment of NOₓ emissions from internal combustion engines of motor vehicles, and especially lean-burn internal combustion engines. SCR systems are also applied to static sources of NOₓ, such as power plants.

One class of SCR catalysts is transition metal exchanged zeolites. Vanadium-based SCR catalysts are unsuited for higher temperature environment due to their thermal instability. This has led to the developments of copper and iron promoted zeolites. Copper zeolite catalysts achieve high NOₓ conversion (90% or more) at relatively low temperatures (from about 180° C. to about 250° C.), but they require the injection of greater amounts of urea to be effective at relatively higher temperatures (greater than about 450° C.). Conventional iron zeolite catalysts achieve high conversion (90% or more) of NOₓ at temperatures over 350° C., but at lower temperatures, more typical of normal diesel engine exhaust (about 180° C. to about 250° C.), high conversions (up to about 90%) are obtained only in the presence of high levels of NO₂ (50% of the total NOₓ levels, i.e. 1:1 NO₂:NO).

It would therefore be desirable to provide SCR catalysts having improved low temperature (from about 180° C. to about 300° C.) performance and/or improved resistance to ageing.

### SUMMARY OF THE INVENTION

The invention reflects the inventors' surprising discovery that the presence of certain groups of organic compounds when iron is introduced into a molecular sieve, can improve the dispersion of the iron to the ion-exchange sites of the molecular sieve, and thereby improve the low-temperature performance and/or the ageing resistance of the molecular sieve. The molecular sieve in these catalysts is preferably a zeolite or a silicoaluminophosphate (SAPO).

Thus, in one aspect, the invention relates to a process for producing an SCR-active molecular sieve based-catalyst, comprising combining a molecular sieve, preferably a zeolite or a SAPO, with at least one ionic iron species and at least one organic compound to form a mixture; and calcining the mixture so as to remove the at least one organic compound. The removal of the at least one organic compound can occur through various processes, including combustion and decomposition.

The molecular sieve is preferably BEA (beta-zeolite), MFI (ZSM-5), FER (ferrierite), CHA (chabasite), AFX, AEI. SFW, SAPO-34, SAPO-56, SAPO-18 or SAV SAPO STA-7.

The organic compound is an oxygen-containing organic compound, such as one or more polycarboxylic acids, a nitrogen-containing compound, such as one or more tetraalkyl ammonium salts, or one or more trialkylamines, or mixtures thereof. Preferably, the organic compound is selected from the group consisting of L-ascorbic acid, citric acid, succinic acid, oxalic acid, sucrose, glucose, ethylene glycol, ethylenediamine, pyrrolidine, di-n-propylamine, diaminooctane, tetramethyl ammonium hydroxide, tetraethyl ammonium hydroxide, tetrapropylammonium bromide, adamantine-substituted tetraalkyl ammonium hydroxides, triethylmethyl ammonium salts, and tetra-n-propylammonium salts. These compounds are termed traditional organic compounds. The term organic compound, as used herein, also includes metal complexes or salts where one of the ions is an organic group. Preferably, the salt comprises iron and an ionic organic group, such as an acetate, citrate, succinate, gluconate, etc. The process can use a plurality of organic compounds, such as a traditional organic compound and an iron organic salt or metal organic complex, as described above.

The process comprises combining a molecular sieve, preferably a zeolite or a SAPO, with at least one ionic iron compound and at least one organic compound and introducing the iron compound to the molecular sieve via suitable catalyst preparation methods such as liquid phase ion-exchange, incipient wetness impregnation, wet impregnation, spray drying and solid-state mixing techniques. These solid-state techniques range from simple loose mixing and grinding through to high energy mixing methods, such as ball milling.

Preferably, the at least one dissolved iron salt is one or more members selected from the group consisting of iron nitrate, iron sulfate, ammonium iron oxalate, iron chloride, iron acetate, iron ammonium sulfate, and iron ammonium citrate, where the iron can be Fe(II) or Fe(III), or a mixture thereof.

The at least one ionic iron species and the least one organic compound are present in a molar ratio from about 1:1 to about 1:10, preferably from about 1:2 to about 1:8, more preferably from about 1:3 to about 1:6, and most preferably about 1:4.

Calcining is performed at a temperature of about 400 to about 600° C. for a time of about 1 to about 3 hours.

In another aspect, the invention also relates to a process of making a catalyst module for abating nitrogen oxides in a gas stream by selective catalytic reduction. A catalyst module is a device containing a catalyst within a housing where the housing comprises one or more inlets for the gas stream to enter the housing, and one or more outlets for the gas to exit after passing through the catalyst in the housing. The process of making the catalyst module comprises combining a molecular sieve, preferably a zeolite or a SAPO, with at least one ionic iron species and at least one organic compound to form a mixture, calcining the mixture and removing the at least one organic compound, forming a catalyst structure by extruding the calcined mixture into a substrate or coating the calcined mixture onto a substrate and mounting the catalyst structure within a housing having one or more inlets for gas to be treated with a reductant such as ammonia or urea in selective catalytic reduction. A catalyst module can also be made by a process comprising preparing a washcoat by forming a mixture comprising a molecular sieve, preferably a zeolite or a SAPO, at least one ionic iron species and at least one organic compound, applying the washcoat to a substrate, calcining the coated mixture and removing the at least one organic compound to form a catalytic structure, and mounting the catalytic structure within a housing having one or more inlets for gas to be treated with a reductant such as ammonia or urea in selective catalytic reduction.

In yet another aspect, the invention relates to an iron-containing molecular sieve, preferably a zeolite or a SAPO, more preferably a ferrierite zeolite, wherein the iron-containing molecular sieve exhibits a selective catalytic reduction of nitrogen oxides with NH₃ or urea of greater than about 25% conversion at 300° C. in exhaust gases prior to ageing or exposure to steam. Preferably, the iron-containing molecular sieve, preferably a zeolite or a SAPO, more preferably a ferrierite zeolite, provides for the conversion of nitrogen oxides at 300° C. that is greater than 30%, more preferably greater than 40%, even more preferably greater than 50%, most preferably greater than 60%.

The use of succinic acid in the manufacture of the catalysts improves NOx conversion of an iron-containing molecular sieve, preferably a zeolite or a SAPO, more preferably a ferrierite zeolite compared to an otherwise identical iron containing molecular sieve prepared without the use of succinic acid. At temperatures between 200° C. and 350° C., catalyst produced using succinic acid have approximately twice or greater NOx conversion compared to a similar catalyst produced without the use of an organic acid. At 300° C., the catalyst produced using succinic acid can have approximately three times the NOx conversion of the catalyst produced without the use of an organic acid.

The use of citric acid or oxalic acid in the manufacture of the catalysts improves NOx conversion of the iron-containing molecular sieve, preferably a zeolite or a SAPO, more preferably a ferrierite zeolite, compared to an otherwise identical iron containing molecular sieve prepared without the use of these acids. At 250° C., catalysts produced using citric acid or oxalic acid have NOx conversions greater than that of a comparable catalyst produced without the use of an organic acid. At 300° C. and 350° C., catalysts produced using citric acid or oxalic acid have NOx conversions of about two times greater than the conversion for a similar catalyst produced without the use of an organic acid.

In another aspect of the invention, the temperature needed for the comparable conversion of NOx is reduced when the catalyst is prepared using an organic acid compared to a comparable catalyst that was prepared without using the organic acid. Temperatures needed for 10% NOx conversion were about 200, 250, 250 and 275° C. for catalysts prepared using succinic acid, oxalic acid, citric acid and without the use of an acid, respectively. Temperatures needed for 50% NOx conversion were about 300, 325, 325 and 375° C. for catalysts prepared using succinic acid, oxalic acid, citric acid and without the use of an acid, respectively. Temperatures needed for 90% NOx conversion were about 340, 375, 390 and 450° C. for catalysts prepared using succinic acid, oxalic acid, citric acid and without the use of an acid, respectively. In addition, the lowest temperatures at which maximum NOx conversion occurs is lower for catalysts prepared using succinic acid, oxalic acid, citric acid and without the use of an acid, with temperatures of about 360, 400, 425 and 475° C. respectively.

In still another aspect, the invention relates to an iron-containing molecular sieve, preferably a zeolite or a SAPO, more preferably a beta zeolite, wherein the molecular sieve exhibits (a) a first selective catalytic reduction of nitrogen oxides with NH₃ or urea of at least 40%, preferably at least 45%, more preferably at least 50% conversion at 300° C. in exhaust gases after ageing for at least 20 hours at 700° C. in the presence of 10% H₂O and (b) a second catalytic reduction of nitrogen oxides with NH₃ or urea of at least 80% conversion at 400° C. in exhaust gases after ageing for 20 hours at 700° C. in the presence of 10% H₂O. Preferably, the first selective catalytic reduction of nitrogen oxides with NH₃ or urea is greater than 50%.

### BRIEF DESCRIPTION OF THE DRAWINGS

Other objects, features and advantages of the invention will become more apparent after reading the following detailed description of examples of the invention, given with reference to the accompanying drawings.

FIG. 1 is a graph showing diffuse-reflectance UV-Vis spectra of Fe/ferrierite zeolites formed using citric, succinic or oxalic acid as the organic additive and an Fe/ferrierite zeolite prepared without an organic additive.

FIG. 2 is fitted spectra from samples produced without and with the use of succinic acid analyzed by Mössbauer spectroscopy.

FIG. 3 is a graph illustrating the NOx conversion using iron containing ferrierite zeolites formed using citric acid, succinic acid or oxalic acid as organic additives and an Fe/ferrierite zeolite prepared without an organic additive.

FIG. 4 is a graph illustrating the NOx conversion using iron ferrierite zeolites formed using different amounts of succinic acid and an Fe/ferrierite zeolite prepared without using succinic acid.

FIG. 5 is a graph illustrating the NOx conversion using iron ferrierite zeolites formed using different iron salts with and without succinic acid as the organic additive.

FIG. 6 is a graph showing diffuse-reflectance UV-Vis spectra of Fe/Beta zeolites formed using citric, succinic or without organic additive.

FIG. 7 is a graph illustrating the NOx conversion using iron-containing Beta zeolites formed using citric acid, succinic acid or ethylenediamine as organic additives and an iron-containing Beta zeolite prepared without an organic additive.

FIG. 8 is a graph illustrating the NOx conversion using iron-containing Beta zeolites formed using different iron salts with citric acid as the organic additive and an Fe/ferrierite zeolite prepared using iron nitrate without an organic additive.

FIG. 9 is a graph comparing the NOₓ conversion using an iron-containing Beta zeolite prepared using L-ascorbic acid with a similar iron-containing Beta zeolite that did not L-ascorbic acid (prepared conventionally), after performing hydrothermal ageing under specified conditions.

### DETAILED DESCRIPTION OF THE INVENTION

As used herein, the term “calcine”, or “calcination”, means heating the material to high temperatures in air or oxygen. This definition is consistent with the IUPAC definition of calcination. (IUPAC. Compendium of Chemical Terminology, 2nd ed. (the “Gold Book”). Compiled by A. D. McNaught and A. Wilkinson. Blackwell Scientific Publications, Oxford (1997). XML on-line corrected version: http://goldbook.iupac.org (2006-) created by M. Nic, J. Jirat, B. Kosata; updates compiled by A. Jenkins. ISBN 0-9678550-9-8. doi: 10.1351/goldbook.)

The term “template” refers to an agent that is added during the process of manufacturing molecular sieves to control the shape and size of pores in a molecular sieve. The use of templates in forming molecular sieves is known in the art.

As used herein, the term “about” means approximately. Approximating language, as used throughout the specification and claims, may be applied to modify any quantitative representation that could permissibly vary without resulting in a change in the basic function to which it is related. Accordingly, a value modified by a term such as “about” is not to be limited to the precise value specified. With regard to the use of the term “about” and specific numerical values encompassed by the term, the number of significant figures, the precision of the value and the context in which the term is used are important in determining the numerical values associated with the term. For example, if a series of measurements are taken over a temperature range from 300° C. to 500° C., where the measurements are made at 25° C. intervals, the term “about 400° C.” would encompass the range from 387° C. to 412° C., inclusive. When “about” is used in describing units of time in hours, the stated value includes a range of plus or minus 15 minutes, inclusive. For example, “about 2 hours” is meant to include time from 1 hour 30 minutes to 2 hours 30 minutes, inclusive. When “about” is used in describing the ratios of amounts of two components, the ratios include values that, when rounded, provide the stated ratio. For example, the term “about 1:4” is meant to include compositions having ratios of 1:3.5 to 1:4.4, inclusive.

The presence of certain types of organic material in a composition comprising a molecular sieve and an ionic iron compound during standard air calcination at temperatures of for example 500° C. can substantially improve the low temperature NH₃ SCR activity of iron containing molecular sieve based catalysts. As discussed in greater detail herein, this effect has been observed for a number of organic molecules (e.g. citric acid, succinic acid, ascorbic acid, oxalic acid) and for both large pore zeolites such as BEA (beta zeolite) and MFI (ZSM-5) as well as medium pore zeolites such as FER (ferrierite) and is also expected to be applicable to small-pore zeolites such as CHA (chabasite), AFX, AEI and SFW. This effect is also expected to be applicable to other molecular sieves, including silicoaluminophosphates, such as SAPO-34, SAPO-56, SAPO-18 and SAV SAPO STA-7.

The effect is attributed to thermal redispersion of iron due to the exotherm generated during calcination with possibly a local reducing environment due to the presence of the organic. Some changes in the nature of the Fe sites, such as the Fe-zeolite interaction or Fe-organic interaction, may also contribute to the enhanced activity. This effect is also expected to be applicable to other molecular sieves, including silicoaluminophosphates, such as SAPO-34.

Incorporation of the organic compound to the molecular sieve may be via impregnation (using such methods as liquid phase ion-exchange, incipient wetness impregnation, wet impregnation, and spray drying), co-impregnation of the organic compound with the iron compound and physical mixing with the catalyst using solid-state mixing techniques. These solid-state techniques range from simple loose mixing and grinding through to high energy mixing methods, such as ball milling.

Mole ratios of iron to the organic compound of about 1:1 to about 1:10 are contemplated, preferably from about 1:2 to about 1:8, more preferably from about 1:3 to about 1:6 and more preferably about 1:4, are to be employed.

The iron may be incorporated into the molecular sieve by isomorphous substitution during synthesis of the molecular sieve, or, alternatively, the iron may be incorporated into the molecular sieve after it is formed, by the techniques described above. It is preferred to incorporate the iron after synthesis of the molecular sieve.

Framework iron resulting from isomorphous substitution is generally considered not to be catalytically active, as discussed for example in U.S. Pat. No. 6,890,501. The presence of iron in the crystal lattice of a molecular sieve might alter the quantity and arrangement of aluminium atoms in the lattice, which in turn could affect the performance of the molecular sieve in undesired ways. On the other hand, a molecular sieve that is first synthesized and then combined with an iron salt will contain substantially only extra-framework iron, with the techniques of the invention increasing the amount of that iron that is present at the catalytically active ion-exchange sites.

The compounds identified herein have been found to promote dispersion of the iron into the zeolite to be improved. A portion of the template used in producing the zeolite may still be present. This effect is also expected to be applicable to other molecular sieves including silicoaluminophosphates (SAPO), such as SAPO-34.

The organic compounds preferred for use according to the invention may also include those which are commonly used as structure directing agents (or templates) during synthesis of the molecular sieve, such as quaternary ammonium salts and hydroxides and alkylamines. The use of such compounds in the invention may have an advantage in that the template molecules used for synthesis of the molecular sieve may serve a dual purpose of directing the synthesis of the molecular sieve and also improving the dispersion of the iron according to the techniques described herein.

Examples of such template molecules include tetramethyl ammonium hydroxide, tetrapropylammonium bromide, adamantine-substituted tetraalkyl ammonium hydroxides and salts, ethylenediamine and other conventional structure-directing agents. The use of such compounds does not necessarily involve isomorphous substitution of iron into the lattice of the molecular sieve, because the iron salt can preferably be added after the molecular sieve has been synthesized, but before the template molecule has been eliminated by calcination. When the iron salt has been added after the molecular sieve has been synthesized, no significant framework iron remains.

Preferably the molecular sieves are small or medium pore. Small pore molecular sieves, including zeolites and silicoaluminophosphates, such as SAPO-34, or some medium pore molecular sieves, including zeolites, such as ferrierite, and silicoaluminophosphates, are advantageous due to their improved resistance to hydrocarbon adsorption. Hydrocarbon tolerance helps to avoid catalyst damage due to exotherms during filter regenerations and inhibition effects during SCR reaction at low temperature. The molecular sieves of the invention preferably display improved iron dispersion and performance at low temperatures (about 180° C. to about 300° C.).

Non-limiting examples of the types of exhaust gases that may be treated with the disclosed molecular sieve based-catalysts include automotive exhaust, including from diesel engines. The disclosed molecular sieves are also suitable for treating exhaust from stationary sources, such as power plants, stationary diesel engines, and coal-fired plants.

The iron-containing molecular sieves of the invention may be provided in the form of a fine powder which is admixed with, or coated by, a suitable refractory binder, such as alumina, bentonite, silica, or silica-alumina, and formed into a slurry which is deposited upon a suitable refractory substrate. The carrier substrate can have a “honeycomb” structure. Such carriers are well known in the art as having a many fine, parallel gas flow passages extending through the structure.

### EXAMPLES

In examples 1-5, powder samples of the catalysts were obtained by pelletizing the original samples, crushing the pellets and then passing the powder obtained through a combination of 255 and 350 micron sieves to obtain a composition having particle sizes between 255 and 350 microns. The powder samples were loaded into a Synthetic Catalyst Activity Test (SCAT) reactor and tested using the following synthetic diesel exhaust gas mixture (at inlet) including nitrogenous reductant: 500 ppm NO, 550 ppm NH₃, 12% O₂, 4.5% H₂O, 4.5% CO₂, 200 ppm CO, balance N₂ at a space velocity of 330 liters per gram of powder catalyst per hour. The samples were heated ramp-wise from 150 to 550° C. at 5° C./min and the composition of the off-gases detected and the activity of the samples to promote NOx reduction was thereby derived.

### Example 1

### Effect of the Addition of Different Organic Acids on SCR Activity of Iron Ferrierite

The low temperature activity of an iron zeolite catalyst can be enhanced by addition of organic acids during the impregnation of iron into the catalyst. The improvement can be attributed to improved iron exchange and redispersion due to an exotherm effect during calcination and possibly creating a locally reducing environment.

Modified 3 wt % Fe/ferrierite catalysts were prepared by impregnating a commercially available ferrierite zeolite with a solution of iron (III) nitrate and an organic acid (citric, succinic or oxalic acid). The molar ratio of Fe:organic acid was 1:4. The samples were dried at 105° C. overnight and then calcined for 2 hours at 500° C.

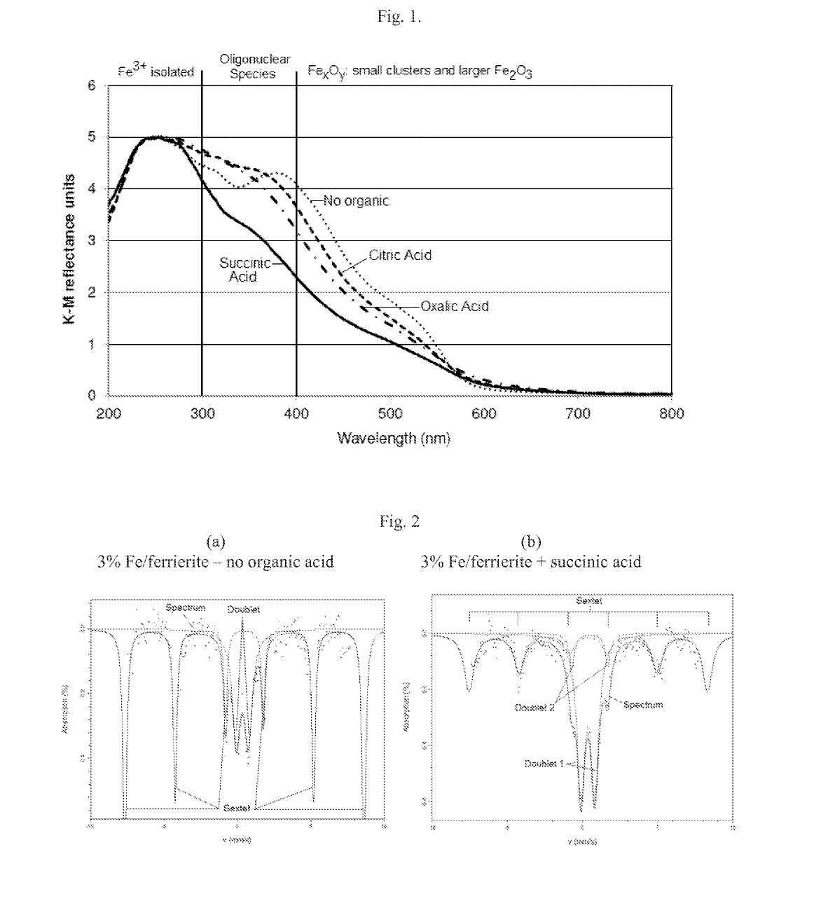

The powder samples were analyzed by diffuse-reflectance UV-Vis in a Perkin-Elmer Lambda 650S spectrometer equipped with an integrating sphere using BaSO4 as a reference. The samples were placed and packed in a holder. The scan interval was set to 1 nm from 190 to 850 nm, the response time was 0.48 sec and a 10% beam attenuator was used in the reference beam. The data was converted to Kubelka-Munk and normalised to 5 to the maximum ordinate. The resulting spectra (See FIG. 1) shows that the addition of organic acids increased the dispersion of iron, and increased the amount of isolated Fe³⁺ species (as shown in the 200-300 nm region) with a decrease of both the dimeric or oligomeric species (as shown in the 300-400 nm region) and the larger Fe oxide species (as shown in the region above 400 nm). These changes were especially significant when succinic acid was used.

Selected powder samples were also analyzed by Mössbauer spectroscopy. ⁵⁷Fe Mössbauer spectroscopy was performed at room temperature using a Wissel constant acceleration spectrometer in transmission mode using a 57Co source in a rhodium matrix. The spectrometer was calibrated relative to α-Fe. The samples were dried and placed in a holder that was glued closed. Mössbauer data were collected over a velocity range of +/−6 mm s⁻¹ and for different periods of time depending on the sample. A calibration run was performed on an α-Fe foil over the same velocity range. All isomer shift values were reported relative to α-Fe and spectra were analysed using the Lorentzian line-shapes facility of RECOIL software [Lagarec K and Rancourt D G, Recoil: Mössbauer spectral analysis software for Windows. http://www.isapps.ca/recoil/]. FIG. 2a is a spectrum of a 3% Fe/ferrierite that was produced without the use of an organic compound. The spectrum has been fitted to one doublet and a sextet. The doublet has parameters indicative of Fe(III) in an octahedral environment as shown by an isomer shift (CS)=0.33 mm/s and quadrupole splitting (QS)=0.85 mm/s. The sextet has parameters indicative of α-Fe₂O₃ (Maddock, A. G., Mössbauer Spectroscopy (1997), Horwood, p 108, at 298K, H=51.5 T, CS=0.38 mm s-1). FIG. 2b is a spectrum of a 3% Fe/ferrierite that was produced with the use of succinic acid. The spectrum has been fitted to two doublets and one sextet. Doublet 1 has parameters indicative of Fe(III) in an octahedral environment (CS=0.34 mm/s and QS=0.92 mm/s). The line width is broad which could indicate a distribution of sites of the iron, or iron held loosely in the structure which would be consistent with the low Mössbauer signal. Doublet 2 has parameters indicative of Fe(II) in a possibly octahedral environment as indicated by the values CS=0.48 mm/s and QS=2.4 mm/s. The sextet has parameters indicative of α-Fe₂O₃ (H=49.1 T, CS=0.38 mm s-1). One of ordinary skill in the art would recognize that both the location of the peaks and the intensity of the peaks can vary depending on numerous factors, including, but not limited to, the age of the source, the length of time of data acquisition, the presence of water in the sample, Fe loadings, as well as the type of molecular sieve used.

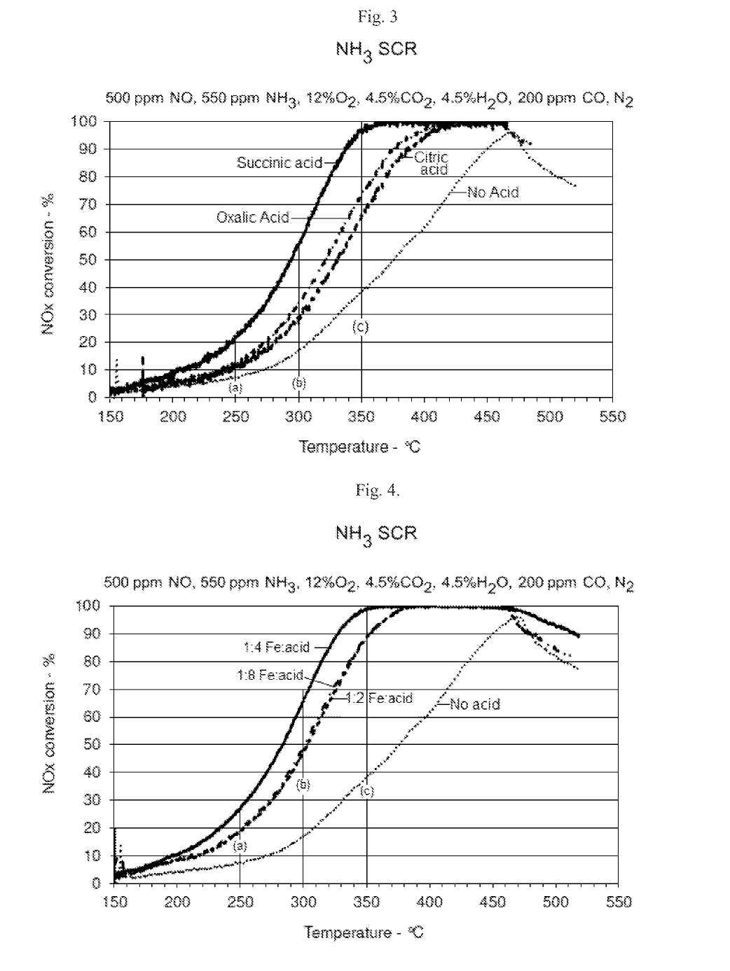

As shown in FIG. 3, the use of citric acid, succinic acid or oxalic acid in each case significantly improved the NOx conversion of the modified iron ferrierite zeolite, in comparison to an otherwise identical iron ferrierite zeolite prepared without the use of such dispersion aids. At 200° C., the catalyst produced using succinic acid had approximately twice the NOx conversion of the catalyst that produced without the use of an organic acid (about 10% and 5%, respectively). At 250° C., the catalyst produced using succinic acid had over twice the NOx conversion of the catalyst produced without the use of an organic acid (about 20% and 8%, respectively)(See line (a)). Catalysts produced using citric acid and oxalic acid had NOx conversions between that of the catalyst produced using succinic acid and the catalyst produced without the use of an organic acid. (See line (a)). At 300° C., the catalyst produced using succinic acid had approximately three times the NOx conversion of the catalyst produced without the use of an organic acid (about 55% and 17%, respectively). (See line (b)). Catalysts produced using citric acid and oxalic acid had NOx conversions of about two times the NOx conversion (28% and 32%, respectively) as the catalyst produced without the use of an organic acid (about 17%). At 350° C., the catalyst produced using succinic acid had over twice the NOx conversion of the catalyst produced without the use of an organic acid (>95% and about 38%, respectively). (See line (c)). Catalysts produced using citric acid and oxalic acid had NOx conversions of about two times the NOx conversion (65% and 73%, respectively) of the catalyst produced without the use of an organic acid (about 38%).

FIG. 3 also shows that the temperatures for 10% NOx conversion were about 200, 250, 250 and 275° C. for catalysts prepared using succinic acid, oxalic acid, citric acid and without the use of an acid, respectively. Temperatures for 50% NOx conversion were about 300, 325, 325 and 375° C. for catalysts prepared using succinic acid, oxalic acid, citric acid and without the use of an acid, respectively. Temperatures for 90% NOx conversion were about 340, 375, 390 and 450° C. for catalysts prepared using succinic acid, oxalic acid, citric acid and without the use of an acid, respectively. The lowest temperatures for maximum NOx conversion were about 360, 410, 430 and 465° C. for catalysts prepared using succinic acid, oxalic acid, citric acid and without the use of an acid, respectively.

These results demonstrate that the use of the organic acids in preparing the catalyst results in significantly higher NOx conversion compared to a comparable catalyst that did not use an organic acid during the preparation of the catalyst. Catalysts produced using the organic acids convert NOx at lower temperatures compared to a comparable catalyst that did not use an organic acid during the preparation of the catalyst.

### Example 2

### Effect of Molar Ratios of Iron to Organic Acid in the Preparation of Iron Ferrierite on Catalytic Activity

Succinic acid was selected as the organic acid to study the effect of different molar ratios of iron to organic acid.

Modified 3 wt % Fe/ferrierite catalysts were prepared by impregnating a commercially available ferrierite zeolite with a solution of iron(III) nitrate and different amounts of succinic acid so that the molar ratio of Fe:organic acid was 1:2, 1:4 and 1:8. The control sample did not have any succinic acid added. The samples were dried at 105° C. overnight and then calcined for 2 hours at 500° C.

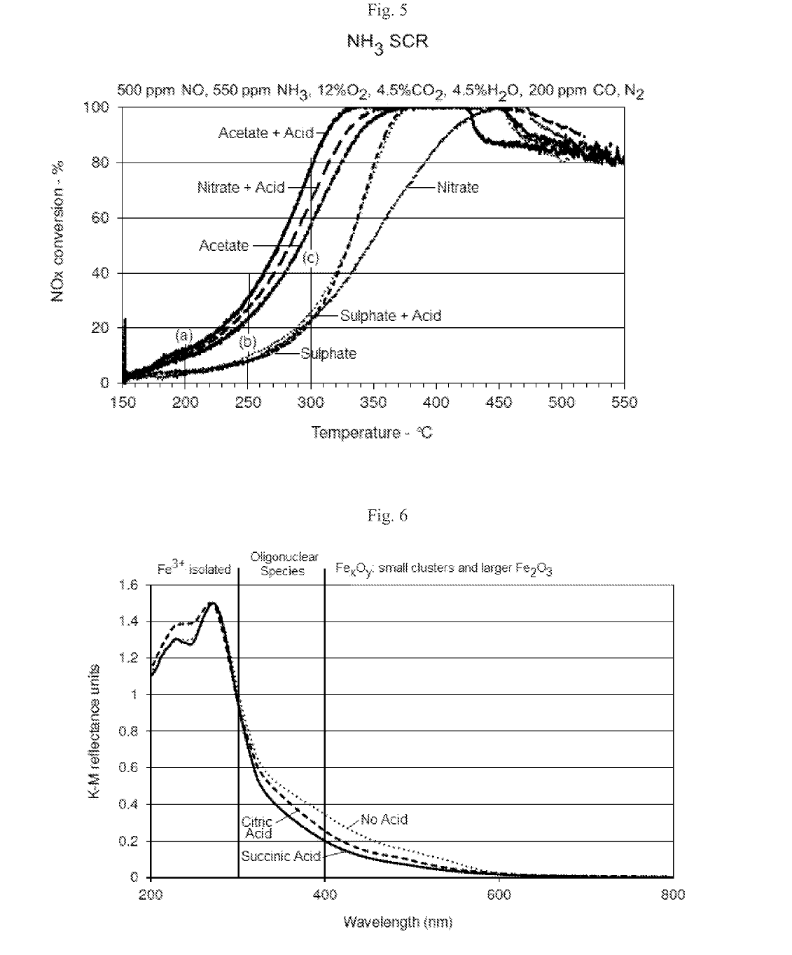

As shown in FIG. 4, at each of the molar ratios of Fe:succinic acid tested, NOₓ conversion was significantly improved in comparison to an otherwise identical iron ferrierite zeolite prepared that did not use succinic acid. At 200° C., the catalyst produced using 1:4 Fe:succinic acid had approximately twice the NOx conversion as the catalyst that did not use succinic acid (about 11% and 5%, respectively). At 250° C. (See line (a)), the catalyst produced using 1:4 Fe:succinic acid had about three times the NOx conversion as the catalyst that did not use succinic acid (about 28% and 8%, respectively). Catalysts produced using 1:2 and 1:8 Fe:succinic acid had NOx conversions that were over twice that of the catalyst that did not use an organic acid. (20%, 20%, 8%) (See line (b)). At 300° C. (See line (b)), the catalyst produced using 1:4 Fe:succinic acid had over three times the NOx conversion as the catalyst that did not use an organic acid (about 67% and 17%, respectively). Catalysts produced using 1:2 and 1:8 Fe:succinic acid had NOx conversions of about three times the NOx conversion (50% and 50%, respectively) as the catalyst that did not use an organic acid (about 17%). At 350° C. (See line (c)), the catalyst produced using 1:4 Fe:succinic acid had over twice the NOx conversion as the catalyst that did not use an organic acid (>98% and about 38%, respectively). Catalysts produced using 1:2 and 1:8 Fe:succinic acid had NOx conversions of over two times the NOx conversion (88% and 88%, respectively) as the catalyst that did not use an organic acid (about 38%).

FIG. 4 also shows that the temperatures for 10% NOx conversion were about 200, 215, 215 and 275° C. for catalysts prepared using Fe:succinic acid at molar ratios of 1:4; 1:8. 1:2 and no acid, respectively. Temperatures for 50% NOx conversion were about 280, 300, 305 and 375° C. for catalysts prepared using Fe:succinic acid at molar ratios of 1:4; 1:8. 1:2 and no acid, respectively. Temperatures for 90% NOx conversion were about 325, 350, 350 and 450° C. for catalysts prepared using Fe:succinic acid at molar ratios of 1:4; 1:8. 1:2 and no acid, respectively. The lowest temperatures for maximum NOx conversion were about 350, 380, 380 and 470° C. for catalysts prepared using Fe:succinic acid at molar ratios of 1:4; 1:8. 1:2 and no acid, respectively.

These results demonstrate that the use of the organic acid in differing molar amounts relative to the amount of iron present in preparing the catalyst results in significantly higher NOx conversion compared to a comparable catalyst that did not use an organic acid during the preparation of the catalyst. These results also indicate that catalysts produced using organic acids in amounts such that the molar ratio of iron to organic acid ranges from 1:2 to 1:8 could convert NOx at lower temperatures compared to a comparable catalyst that did not use an organic acid during the preparation of the catalyst. Among the tested mole ratios, a ratio of 1:4 of iron:organic acid was found to be optimal.

### Example 3

### Effect of Iron Salt Precursors in Iron Ferrierite on Catalytic Activity

Succinic acid was selected as the organic acid to study the effect of different iron salts on the catalytic activity of the catalyst.

Modified 3 wt % Fe/ferrierite catalysts were prepared by impregnating a commercially available ferrierite zeolite with a solution of succinic acid and iron (III) nitrate, iron (II) acetate or iron (II) sulphate to give a molar ratio of Fe:organic acid of 1:4. Control samples did not have any succinic acid added. The samples were dried at 105° C. overnight and then calcined for 2 hours at 500° C.

As shown in FIG. 5, samples produced using acetate, acetate plus succinic acid and nitrate plus succinic acid provided significantly improved NOₓ conversion in comparison to samples produced using nitrate, sulphate or sulphate plus succinic acid. At 200° C., catalyst produced using acetate, acetate plus succinic acid and nitrate plus succinic acid had approximately twice the NOx conversion as catalysts produced using nitrate, sulphate or sulphate plus succinic acid. (See line (a)). At 250° C., the catalyst produced using acetate, acetate plus succinic acid and nitrate plus succinic acid had about 2.5 to about 3 times the NOx conversion as catalysts produced using nitrate, sulphate or sulphate plus succinic acid (See line (b)). At 300° C., the catalyst produced using acetate, acetate plus succinic acid and nitrate plus succinic acid had about 2.5 to about 3 times the NOx conversion as catalysts produced using nitrate, sulphate or sulphate plus succinic acid. (See line (c)).

FIG. 5 also shows that the temperatures for 10% NOx conversion were about 200° C. for catalysts prepared using acetate, acetate plus succinic acid and nitrate plus succinic acid and were about 250° C. for catalysts produced using nitrate, sulphate or sulphate plus succinic acid. Temperatures for 50% NOx conversion were about 270 to about 290° C. for catalysts prepared using acetate, acetate plus succinic acid and nitrate plus succinic acid and were about 330 to about 350° C. for catalysts produced using nitrate, sulphate or sulphate plus succinic acid.

Temperatures for 90% NOx conversion were about 310 to about 340° C. for catalysts prepared using acetate, acetate plus succinic acid and nitrate plus succinic acid and were about 360 to about 415° C. for catalysts produced using nitrate, sulphate or sulphate plus succinic acid. The lowest temperatures for maximum NOx conversion were about 330 to about 360° C. for catalysts prepared using acetate, acetate plus succinic acid and nitrate plus succinic acid and were about 370 to about 450° C. for catalysts produced using nitrate, sulphate or sulphate plus succinic acid.

These results demonstrate that the iron salt used in preparing the catalyst can result in widely differing amounts of NOx conversion.

### Example-4

### Effect of the Addition of Organic Acids or Bases on SCR Activity of Iron Beta Zeolite

The low temperature activity of an iron zeolite catalyst can be enhanced by addition of organic acids or bases during the impregnation of iron into the catalyst. The improvement can be attributed to improved iron exchange and redispersion due to an exotherm effect during calcination that creates a locally reducing environment.

Modified 5 wt % Fe/Beta catalysts were prepared by impregnating a commercially available Beta zeolite with a solution of iron(III) nitrate and either citric acid, succinic acid or ethylenediamine (EDA) to give an Fe:organic additive molar ratio of 1:4. The samples were dried at 105° C. overnight and then calcined for 2 hours at 500° C.

Diffuse-reflectance UV-Vis was applied to powder samples and the data was normalised to the maximum ordinate. Diffuse-reflectance UV-Vis shows (See FIG. 6) that the addition of organic additives increased the dispersion of iron, and increased the amount of isolated Fe³⁺ species (as shown in the 200-300 nm region) with a decrease of both the dimeric or oligomeric species (as shown in the 300-400 nm region) the larger Fe oxide species (as shown in the region above 400 nm). These changes were especially significant when succinic acid was used.

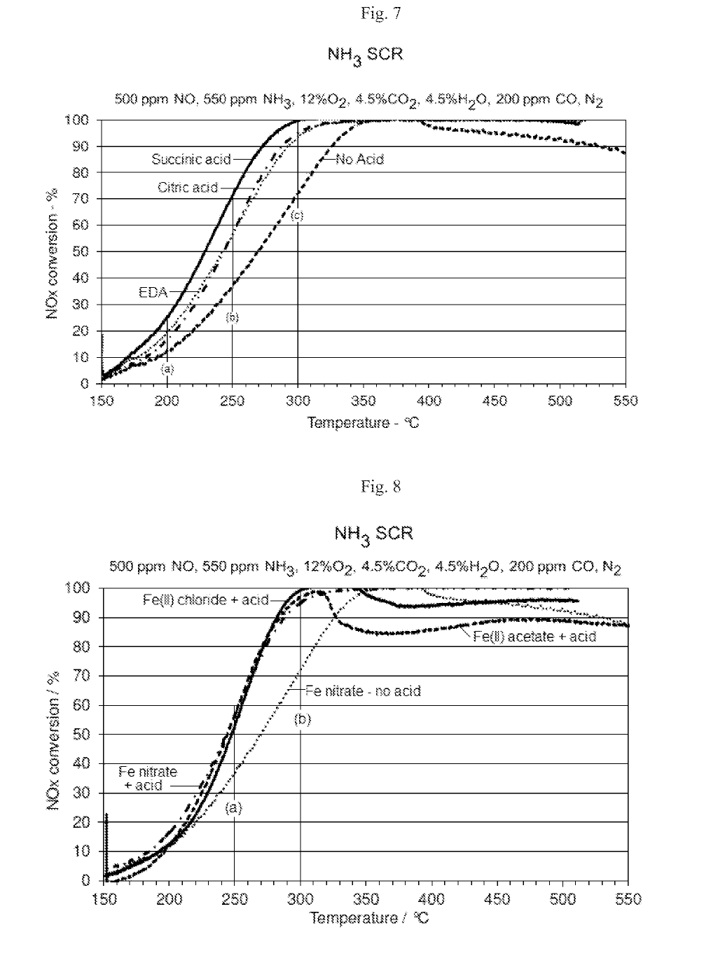

As shown in FIG. 7, the use of citric acid, succinic acid or ethylenediamine (EDA) in each case significantly improved the NOx conversion of the modified iron Beta zeolite, in comparison to an otherwise identical iron Beta zeolite prepared without the use of such dispersion aids. At 200° C., the catalyst produced using succinic acid had approximately twice the NOx conversion of the catalyst produced without the use of an organic acid or base (about 24% and 11%, respectively), while the catalysts produced using citric acid and EDA had approximately 1.5 times the NOx conversion of the catalyst produced without the use of an organic acid or base (See line (a)). At 250° C., the catalyst produced using succinic acid had about twice the NOx conversion of the catalyst produced without the use of an organic acid or base (about 70% and 36%, respectively), while catalysts produced using citric acid and EDA had NOx conversions that were about 1.5 times that of the catalyst produced without the use an organic acid or base. (See line (b)). At 300° C., the catalyst produced using succinic acid, citric acid and EDA had significantly higher NOx conversions than that of the catalyst produced without the use of an organic acid or base (about 99, 95, 93% and 72%, respectively). (See line (c)).

FIG. 7 also shows that the temperatures for 10% NOx conversion were about 170, 175, 180 and 190° C. for catalysts prepared using succinic acid, EDA, citric acid and without the use of an organic acid or base, respectively. Temperatures for 50% NOx conversion were about 230, 240, 240 and 270° C. for catalysts prepared using succinic acid, citric acid, EDA and without the use of an organic acid or base, respectively. Temperatures for 90% NOx conversion were about 270, 290, 290 and 330° C. for catalysts prepared using succinic acid, citric acid, EDA and without the use of an organic acid or base, respectively. The lowest temperatures for maximum NOx conversion were about 300, 320, 320 and 350° C. for catalysts prepared using succinic acid, citric acid, EDA and without the use of an organic acid or base, respectively.

These results demonstrate that the use of an organic acid or base in preparing the catalyst results in significantly higher NOx conversion compared to a comparable catalyst that did not use an organic acid or base during the preparation of the catalyst. Catalysts produced using the organic acids or bases convert NOx at lower temperatures compared to a comparable catalyst that did not use an organic acid or base during the preparation of the catalyst.

### Example 5

### Effect of Iron Salt Precursors on Catalytic Activity when Adding Organic Acid to Iron Beta

Citric acid was selected to study the effect of different iron salt precursors on SCR activity when adding an organic acid to iron Beta.

Modified 5 wt. % Fe/Beta catalysts were prepared by impregnating a commercially available Beta zeolite with a solution of citric acid and either iron (III) nitrate, iron (II) acetate or iron (II) chloride, to give an Fe:organic acid molar ratio of 1:4. The control sample did not have any citric acid added. The samples were dried at 105° C. overnight and then calcined for 2 hours at 500° C.

As shown in FIG. 8, for each of the iron salts tested, NOₓ conversion was significantly improved in comparison to an otherwise identical iron Beta zeolite catalyst prepared that did not use succinic acid. At 250° C., the catalyst produced using an iron salt with citric acid had approximately 1.5 times the NOx conversion as the catalyst produced with iron (III) nitrate without the use of citric acid. (See line (a)). At 300° C., the catalyst produced using an iron salt with citric acid had approximately 1.35 times the NOx conversion as the catalyst produced with iron (III) nitrate without the use of citric acid. (See line (b)).

FIG. 8 also shows that the temperatures for 50% NOx conversion were about 250° C. when each of the iron salts were used, while a temperature of about 270° C. was needed when iron(III) nitrate was used without citric acid. The temperature for 90% NOx conversion was about 280° C. for catalysts prepared using Fe salts and citric acid, but increased to about 330° C. for catalysts prepared using Fe(III) nitrate without using citric acid. The lowest temperatures for maximum NOx conversion were about 300 to about 320° C. for catalysts prepared using Fe salts and citric acid but was about 350° C. for catalysts prepared using Fe(III) nitrate without citric acid.

These results demonstrate that the use of different iron salts with organic acid in preparing the catalyst results in significantly higher NOx conversion compared to a comparable catalyst that did not use organic acid during the preparation of the catalyst. These results also indicate that catalysts produced using iron salts with organic acids in amounts such that the molar ratio of iron to organic acid was about 1:4 could convert NOx at lower temperatures compared to a comparable catalyst that did not use an organic acid during the preparation of the catalyst.

### Example 6

### Resistance of Iron-Containing Zeolites to Hydrothermal Ageing

The techniques described herein have also been found to improve the resistance of iron-containing zeolites to hydrothermal ageing, in addition or alternatively to the improved low temperature performance.

Iron (III) nitrate was dissolved in deionized water, to which L-ascorbic acid was then added, followed by mixing for 30 min. A commercially available beta zeolite powder was then added to the slurry and mixed for a further three hours. Colloidal silica and boehmite alumina powder were added to the slurry while mixing, followed by scleroglucan to thicken the slurry, followed by another one hour of mixing. The resulting slurry was then coated on a catalyst substrate, and subjected to hydrothermal ageing at 700° C. and 10% H₂O for 20 hours. A similar catalyst was prepared without the addition of L-ascorbic acid.

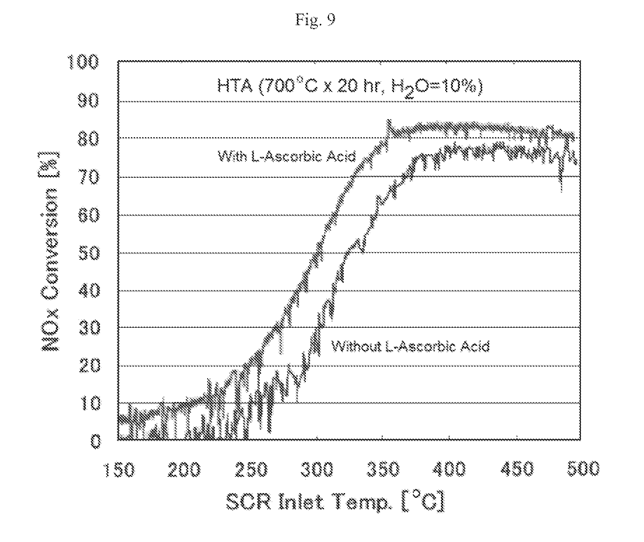

The NOx conversion of these two catalysts was evaluated at SCR inlet temperatures between 150° C. and 500° C. using the method described above. FIG. 9 shows a comparison of NOx conversion from the catalyst prepared with L-ascorbic acid and from the catalyst prepared in the same manner but without the addition of L-ascorbic acid. At temperatures below about 225° C., the catalyst prepared without the addition of L-ascorbic acid had little or no NOx conversion, while the catalyst prepared with L-ascorbic acid had between about 5% and about 15% NOx conversion. At temperatures from about 250° C. to about 300° C., the catalyst prepared with L-ascorbic acid had about twice the amount of NOx conversion as the catalyst prepared without L-ascorbic acid. (20% versus 10% at 250° C. and 50% versus 25% at 300° C.). At 350° C., the catalyst prepared with L-ascorbic acid had NOx conversion of about 75%, while the catalyst prepared without L-ascorbic acid had NOx conversion of about 65%. At temperatures above about 350° C., the catalyst prepared with L-ascorbic acid had NOx conversion of about 5 to about 10% greater than that from the catalyst prepared without L-ascorbic acid. Catalyst prepared with L-ascorbic acid produced similar amount of NOx conversion at temperatures about 25 to about 50° C. below that required from the catalyst prepared without L-ascorbic acid. (200° C. versus 250° C. for 10% NOx conversion. 250° C. versus 290° C. for 20% NOx conversion, and 300° C. versus 325° C. for 50% NOx conversion.) This shows that a catalyst prepared according to the invention displayed markedly superior NOₓ conversion after having been subjected to the specified hydrothermal ageing conditions.

It will be understood that the foregoing description and specific examples shown herein are merely illustrative of the invention and the principles thereof, and that modifications and additions may be easily made by those skilled in the art without departing from the spirit and scope of the invention, which is therefore understood to be limited only by the scope of the appended claims.

1. A process for producing an SCR-active molecular sieve based-catalyst,
comprising:
combining a molecular sieve with at least one ionic iron species and at least one organic compound to form a mixture; and
removing the at least one organic compound by calcining the mixture.

2. The process of claim 1, wherein the molecular sieve is a zeolite or a silicoaluminophosphate (SAPO)

3. The process according to claim 1, wherein the molecular sieve is BEA, MFI, FER, CHA, AFX, AEI, SFW, SAPO-34, SAPO-56, SAPO-18 or SAV SAPO STA-7.

4. The process according to claim 1, wherein the organic compound is an oxygen-containing organic compound or a nitrogen-containing compound.

5. The process according to claim 1, wherein the organic compound is a polycarboxylic acid, a tetraalkyl ammonium salt or a trialkylamine.

6. The process according to claim 1, wherein the organic compound is selected from the group consisting of L-ascorbic acid, citric acid, succinic acid, oxalic acid, sucrose, glucose, ethylene glycol and ethylenediamine.

7. The process according to claim 1, wherein the organic compound is selected from the group consisting of tetramethyl ammonium hydroxide, tetraethyl ammonium hydroxide, tetrapropylammonium bromide, adamantine-substituted tetraalkyl ammonium hydroxides, triethylmethyl ammonium salts and tetra-n-propylammonium salts.

8. The process according to claim 1, wherein the organic compound is selected from the group consisting of pyrrolidine, di-n-propylamine and diaminooctane.

9. The process according to claim 1, wherein said combining comprises introducing the at least one ionic iron species and at least one organic compound to the molecular sieve via liquid phase ion-exchange, incipient wetness impregnation, wet impregnation, spray drying and solid-state mixing techniques.

10. The process according to claim 9, wherein the at least one dissolved iron salt and said at least one organic compound are in a solution.

11. The process according to claim 1, wherein the at least one dissolved iron salt is selected from the group consisting of iron nitrate, iron sulphate, ammonium iron oxalate, iron chloride, iron acetate, iron ammonium sulphate, and iron ammonium citrate, where the iron is Fe(II) or Fe(III), or a mixture thereof.

12. The process according to claim 1, wherein the molecular sieve, the at least one ionic iron species and the at least one organic compound are combined using a solid-state mixing technique.

13. The process according to claim 1, wherein the at least one ionic iron species and the at least one organic compound are present in a molar ratio from about 1:1 to about 1:10.

14-16. (canceled)

17. The process according to claim 1, wherein the calcining is performed at a temperature of about 400 to about 600° C. for a time of about 1 to about 3 hours.

18. (canceled)

19. (canceled)

20. An iron-containing zeolite, wherein said zeolite exhibits a selective catalytic reduction of nitrogen oxides with NH₃ or urea at 300° C. in exhaust gases that is at least 20% greater than that of a comparable iron-containing zeolite that has not been treated with an organic compound, where the reduction of nitrogen oxides is measured prior to ageing or exposure to steam.

21. The iron-containing zeolite according to claim 20, wherein the zeolite is a ferrierite.

22. (canceled)

23. An iron-containing zeolite, wherein said zeolite exhibits a selective catalytic reduction of nitrogen oxides with NH₃ or urea of (a) greater than 40% conversion at 300° C. in exhaust gases after ageing for 20 hours at 700° C. in the presence of 10% H₂O; and (b) greater than 80% conversion at 400° C. in exhaust gases after ageing for 20 hours at 700° C. in the presence of 10% H₂O.

24. The iron-containing zeolite according to claim 23, wherein the zeolite is a beta-zeolite.

25. (canceled)

26. An SCR-active iron-containing ferrierite having a Mossbauer spectrum comprising:
two doublets having isomer shifts (CS) and quadrupole splitting (QS) of:
(a) CS=0.34 mm/s and QS=0.92 mm/s; and
(b) CS=0.48 mm/s and QS=2.4 mm/s, and
a sextet having H=49.1 T, CS=0.38 mm/s
wherein the values for CS and QS are ±0.02 mm/s.

27-40. (canceled)

41. An iron-containing zeolite, wherein said zeolite exhibits a selective catalytic reduction of nitrogen oxides with NH₃ or urea at 300° C. in exhaust gases that is at least 20% greater than that of a comparable zeolite that has not been treated with an organic compound, where the reduction of nitrogen oxides are measured prior to ageing or exposure to steam.

42. (canceled)

43. (canceled)

44. An iron-containing zeolite, wherein said zeolite exhibits a selective catalytic reduction of nitrogen oxides with NH₃ or urea of (a) greater than 40% conversion at 300° C. in exhaust gases after ageing for 20 hours at 700° C. in the presence of 10% H₂O; and (b) greater than 80% conversion at 400° C. in exhaust gases after ageing for 20 hours at 700° C. in the presence of 10% H₂O.

45-48. (canceled)
